(19) United States
(12) Patent Application Publication
(10) Pub. No.: US 2026/0138068 A1
(43) Pub. Date: May 21, 2026

(54) AIR TREATMENT APPARATUS

(71) Applicant: Hy Cite Enterprises, LLC, Middleton, WI (US)

(72) Inventors: Aric Dichraff, McFarland, WI (US); Jeremy Miller, Fitchburg, WI (US); Jose Santiago, New York, NY (US); Craig Stevenson, Fitchburg, WI (US); Michael Brucki, Madison, WI (US); Ray Hubert, Muscoda, WI (US); Enoch Xu, Fujian (CN); Jason Zhao, Fujian (CN); Ben Feng, Fujian (CN)

(21) Appl. No.: 19/394,350

(22) Filed: Nov. 19, 2025

Related U.S. Application Data
(60) Provisional application No. 63/722,417, filed on Nov. 19, 2024.

(51) Int. Cl. B01D 46/00; B01D 46/42; B01D 53/26; F24F 1/0071; F24F 1/0083; F24F 1/0087; F24F 13/20

(52) U.S. Cl. CPC B01D 46/0013; B01D 46/0038; B01D 46/4254; B01D 53/26; F24F 1/0071; F24F 1/0083; F24F 1/0087; F24F 13/20; B01D 2257/80

(57) ABSTRACT

A modular air treatment assembly includes a base module, at least one intermediate module stacked on the base module, the at least one intermediate module removably connected to the base module, and a top module stacked on the at least one intermediate module, the at least one top module removably connected to the intermediate module, wherein electrical power provided to the base module is communicated to the at least one intermediate module and the top module.

### CROSS-REFERENCE TO RELATED APPLICATIONS

The present application claims priority to U.S. Provisional Patent Application No. 63/722,417, filed on Nov. 19, 2024 and entitled “Air Treatment Apparatus,” the contents of which is hereby incorporated by reference in its entirety.

### FIELD

The present disclosure relates to an air treatment apparatus. More specifically, the present disclosure relates to a modular air treatment apparatus including a plurality of modules. The modular air treatment apparatus can be arranged in a plurality of different configurations, with each configuration including a different number and/or a different arrangement of the plurality of modules.

### SUMMARY

In one example of an embodiment, a modular air treatment assembly includes a base module, at least one intermediate module stacked on the base module, the at least one intermediate module removably connected to the base module, and a top module stacked on the at least one intermediate module, the at least one top module removably connected to the intermediate module. Electrical power provided to the base module is communicated to the at least one intermediate module and the top module.

In another example of an embodiment of the modular air treatment assembly, the base module includes an illumination source.

In another example of an embodiment of the modular air treatment assembly, the illumination source is positioned around a periphery of a bottom side of the base module.

In another example of an embodiment of the modular air treatment assembly, the at least one intermediate module includes a dehumidifier module.

In another example of an embodiment of the modular air treatment assembly, the dehumidifier module includes a water tank configured to receive water condensed from intake air drawn from outside the dehumidifier module.

In another example of an embodiment of the modular air treatment assembly, the water tank is a drawer that partially defines an external housing of the dehumidifier module.

In another example of an embodiment of the modular air treatment assembly, the drawer is configured to be detached from the dehumidifier module.

In another example of an embodiment of the modular air treatment assembly, the at least one intermediate module includes a humidifier module.

In another example of an embodiment of the modular air treatment assembly, the humidifier module includes a door that partially defines an external housing of the humidifier module.

In another example of an embodiment of the modular air treatment assembly, the door is configured to pivot between a closed position and an open position, wherein in response to the door being in the open position, a second tank is configured to receive a humidification liquid through the door.

In another example of an embodiment of the modular air treatment assembly, the at least one intermediate module includes a dehumidifier module and a humidifier module.

In another example of an embodiment of the modular air treatment assembly, the humidifier module is stacked on the base module, the humidifier module is removably connected to the base module, and the dehumidifier module is stacked on the humidifier module, the dehumidifier module is removably connected to the humidifier module.

In another example of an embodiment of the modular air treatment assembly, the dehumidifier module is stacked on the base module, the dehumidifier module is removably connected to the base module, and the humidifier module is stacked on the dehumidifier module, the humidifier module is removably connected to the dehumidifier module.

In another example of an embodiment of the modular air treatment assembly, the at least one intermediate module includes an air filter module including a first fan and an air filter.

In another example of an embodiment of the modular air treatment assembly, the air filter includes a HEPA filter.

In another example of an embodiment of the modular air treatment assembly, the at least one intermediate module includes a humidifier module, a dehumidifier module, or at least one air filter module.

In another example of an embodiment of the modular air treatment assembly, each intermediate module includes a first mounting interface positioned on a first side of the module, and a second mounting interface positioned on a second side of the module, each first mounting interface is configured to engage the second mounting interface of an adjacent intermediate module.

In another example of an embodiment of the modular air treatment assembly, each first mounting interface includes a recessed channel positioned concentric to a central projection, and each second mounting interface includes a raised projection positioned concentric to a central recess, wherein the recessed channel of the first mounting interface is configured to receive the raised projection of the second mounting interface of an adjacent intermediate module, and the central projection of the first mounting interface is configured to be received by the central recess of the second mounting interface of the adjacent intermediate module.

In another example of an embodiment of the modular air treatment assembly, wherein the first mounting interface includes at least one electrical plug and the second mounting interface includes at least one electrical socket, wherein the at least one electrical plug of the first mounting interface is configured to be received by the at least one electrical socket of the second mounting interface of the adjacent intermediate module to electrically connect adjacent intermediate modules.

In another example of an embodiment of the modular air treatment assembly, the top module includes a fan in fluid communication with a removable tray, the removable tray is configured to receive an aroma dispensing device, and the fan is configured to generate air flow directed towards the aroma dispensing device.

### BRIEF DESCRIPTION OF THE DRAWINGS

FIG. 1 is a perspective view of an example of an embodiment of an air treatment apparatus including a base module, a dehumidifier module, a humidifier module, a plurality of air filter modules, and a top module, the perspective view showing a front, a first side, and a top of the apparatus.

FIG. 2 is another perspective view of the air treatment apparatus of FIG. 1, the perspective view showing a back, a second side, and a bottom of the apparatus.

FIG. 3 is a top view of the air treatment apparatus of FIG. 1.

FIG. 4 is a bottom view of the air treatment apparatus of FIG. 1.

FIG. 5 is a cross-sectional view of the air treatment apparatus, taken along line 5-5 in FIG. 3.

FIG. 6 is a cross-sectional view of the air treatment apparatus, taken along line 6-6 in FIG. 3.

FIG. 7 is a perspective view of a portion of the air treatment apparatus of FIG. 1, illustrating a tank drawer of the dehumidifier module in a partially removed state and a door of the humidifier module in a partially open state.

FIG. 8 is a perspective view of the humidifier module of FIG. 1, illustrating the door in the open state.

FIG. 9 is a perspective view of the top module of the air treatment apparatus of FIG. 1, with a housing of the top module removed.

FIG. 10 is a partially exploded view of the air treatment apparatus of FIG. 1, illustrating the modules in a disengaged configuration.

FIG. 11 is a partially exploded view of the air treatment apparatus of FIG. 2 illustrating the modules in the disengaged configuration.

FIG. 12 is a top perspective view of the air filter module of FIG. 1.

FIG. 13 is a bottom perspective view of the air filter module of FIG. 1.

FIG. 14 is an enlarged cross-sectional view of a connection between two adjacent modules, taken along line 14-14 in FIG. 5.

FIG. 15 is a top perspective view of the humidifier module of FIG. 1.

FIG. 16 is a perspective view of another embodiment of a top module for use in the air treatment apparatus of FIG. 1, the top module shown coupled to the air filter module.

FIG. 17 is a top view of the top module of FIG. 16.

FIG. 18 is a top view of a user interface of the top module of FIG. 16.

FIG. 19 is a perspective view of another example of an embodiment of an air treatment apparatus including a base module, a dehumidifier module, a humidifier module, an air filter module, an aroma module, and a top module, the perspective view showing a front, a first side, and a top of the apparatus.

FIG. 20 is another perspective view of the air treatment apparatus of FIG. 19, the perspective view showing a back, a second side, and a bottom of the apparatus.

FIG. 21 is a partially exploded view of the air treatment apparatus of FIG. 19 illustrating the modules in a disengaged configuration.

FIG. 22 is a top perspective view of the air treatment apparatus of FIG. 19, illustrating the air filter module, the aroma module, and the top module.

FIG. 23 is a top view of the air treatment apparatus of FIG. 19.

FIG. 24 is a top view of a user interface of the top module of FIG. 19.

FIG. 25 is a front perspective view of a remote controller for use with the air treatment apparatus of FIG. 1 or 16.

FIG. 26 is a rear perspective view of the remote controller of FIG. 25.

Before embodiments of the disclosure are explained in detail, it is to be understood that the disclosure is not limited in its application to the details of construction and the arrangement of components set forth in the following description or illustrated in the accompanying drawings. The disclosure is capable of supporting other embodiments and of being practiced or of being carried out in various ways.

### DETAILED DESCRIPTION

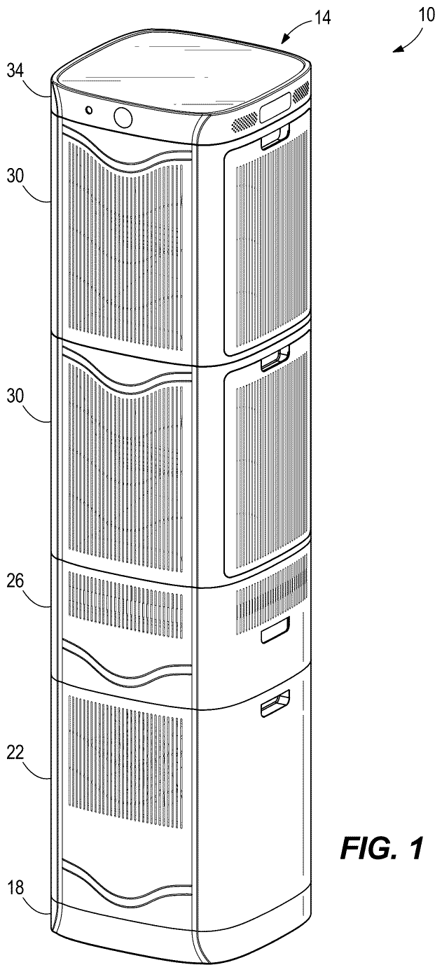

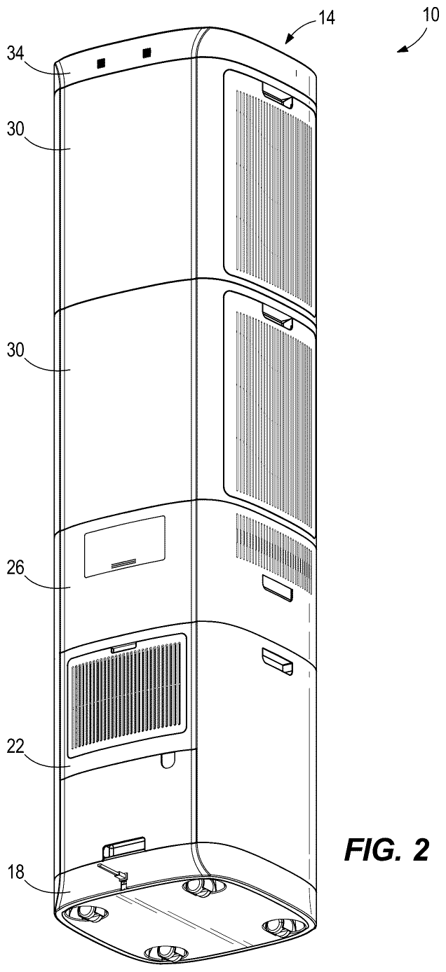

With reference to FIGS. 1 and 2, an embodiment of an air treatment apparatus 10 (also referred to as an air treatment assembly 10) is illustrated. The air treatment apparatus 10 includes a plurality of modules 14. The plurality of modules 14 can include a base module 18 (also referred to as a first module 18), a dehumidifier module 22 (also referred to as a second module 22), a humidifier module 26 (also referred to as a third module 26), an air filter module 30 (also referred to as a fourth module 30 or an air purifier module 30), and a top module 34 (also referred to as a fifth module 34 or a control module 34). The illustrated apparatus 10 includes one base module 18, one dehumidifier module 22, one humidifier module 26, two air filter modules 30, and one top module 34. In each embodiment, the apparatus 10 includes one base module 18 and one top module 34. While FIGS. 1 and 2 illustrate one arrangement for the plurality of modules 14, it should be appreciated that the apparatus 10 can be arranged with different module arrangement configurations. In each of such arrangements, the base module 18 is illustrated as the lowermost module 14 (or the module 14 adjacent a ground surface), and the top module 34 is illustrated as an uppermost module 14 (or the module 14 furthest from a ground surface). In one example of an embodiment, at least one intermediate module is positioned in a stacked arrangement between the base module 18 and the top module 34. The at least one intermediate module can include the dehumidifier module 22, the humidifier module 26, or the air filter module 34. In another example of an embodiment, the intermediate module can include a plurality of intermediate modules. The intermediate modules can include the dehumidifier module 22, the humidifier module 26, and/or one or more air filter modules 34. In one example of an embodiment, the intermediate modules can include a plurality of air filter modules 34. In another example of an embodiment, the intermediate modules can include one air filter module 34 and the humidifier module 26. In another example of an embodiment, the intermediate modules can include a first air filter module 34, a second air filter module 34, and a humidifier module 26. In another example of an embodiment, the intermediate modules can include one air filter module 34 and the dehumidifier module 22. In another example of an embodiment, the intermediate modules can include a first air filter module 34, a second air filter module 34, and the dehumidifier module 22. In another example of an embodiment, the intermediate modules can include one air filter module 34, the humidifier module 26, and the dehumidifier module 22. In another example of an embodiment, the intermediate modules can include a first air filter module 34, a second air filter module 34, the humidifier module 26, and the dehumidifier module 22.

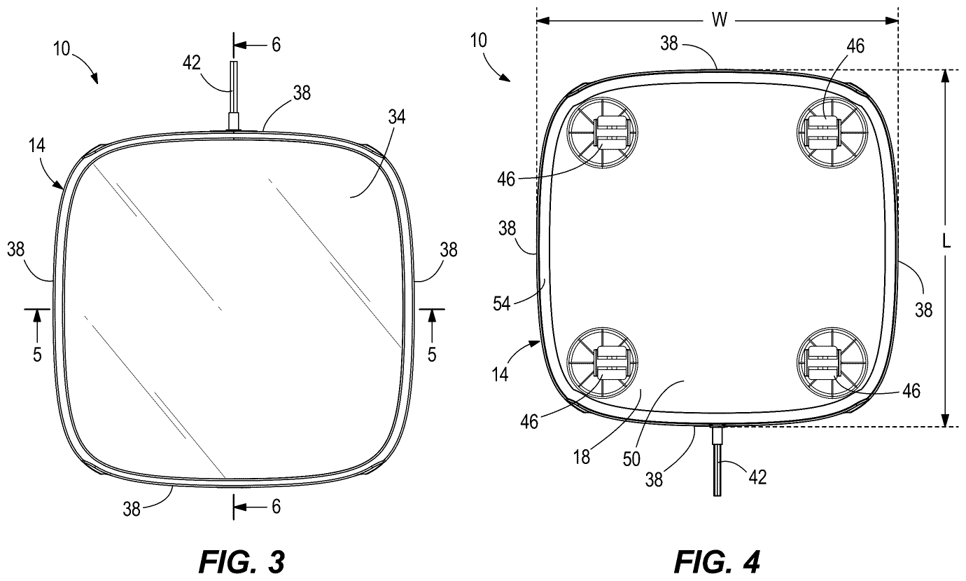

With reference to FIGS. 3 and 4, each module 14 has the same footprint. The footprint is the shape of the respective module 14 when viewed from the top (FIG. 3) or the bottom (FIG. 4). The similar footprint of each module 14 provides for a desired geometry of the apparatus 10 when a plurality of modules 14 are stacked into a configuration. In the illustrated embodiment, each module 14 includes four sides 38. Each illustrated side 38 is convex. In other embodiments, one or more of the sides 38 can be flat, concave, or can form any geometric shape.

With specific reference to FIG. 4, each module 14 defines a length L and a width W. The length L and width W are each measured between two opposite sides 38. In the illustrated embodiment, the length L and width W are equivalent, such that the footprint is generally square. More specifically, the illustrated length L and width W are each 380 millimeters (mm). In other embodiments, the length L and width W can be different, such that the footprint is generally rectangular. In yet other embodiments, the length L and width W can be a different value. For example, the length L and/or the width W can be 350 mm, 400 mm, 450 mm, or any other value suitable to contain the components of each respective module 14.

With continued reference to FIG. 4, a power cord 42 is connected to the base module 18. The power cord 42 is configured to supply electrical power to the base module 18. The base module 18 is configured to direct the electrical power to the other modules 14 in the apparatus 10. The base module 18 also includes a plurality of wheels 46 on a bottom side 50 of the base module 18. The wheels 46 are configured to engage a ground surface to facilitate rolling movement of the apparatus 10 along the ground surface. The illustrated base module 18 includes four caster wheels 46 positioned at adjacent corners of the base module 18. In other embodiments, the base module 18 can include any suitable number of wheels 46 positioned in any suitable arrangement to facilitate movement of the apparatus 10 along the ground surface while maintaining sufficient stability to maintain the apparatus 10 in an upright position. The base module 18 can include an illumination source 54 (or light 54). In the illustrated embodiment, the light 54 is positioned around a periphery of the bottom side 50 of the base module 18. The light 54 can function as, for example, a night light to illuminate around the apparatus 10 in the dark. The light 54 can also emit different colors or visible wavelengths of light (e.g., white, yellow, green, blue, purple, etc.), and light of different intensity.

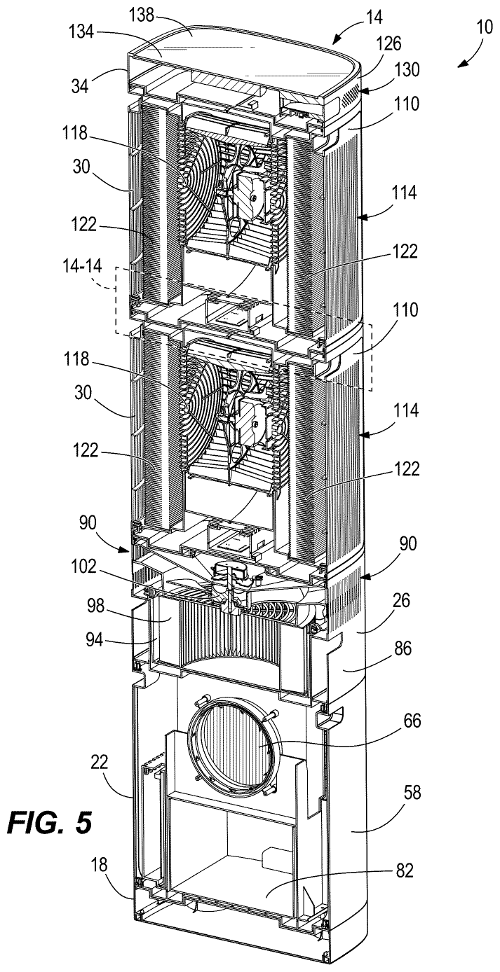

With reference now to FIGS. 5-7, the dehumidifier module 22 can be coupled to the base module 18. The dehumidifier module 22 can be mechanically and electrically coupled to the base module 18. In addition, the dehumidifier module 22 can be removably coupled to the base module 18. The base module 18 can route power to the dehumidifier module 22 through electrical connections between the base module 18 and the dehumidifier module 22, which is described in further detail below. The dehumidifier module 22 is configured to remove humidity (or water vapor) from the surrounding air. The dehumidifier module 22 includes a dehumidifier housing 58 positioned around a periphery of the dehumidifier module 22.

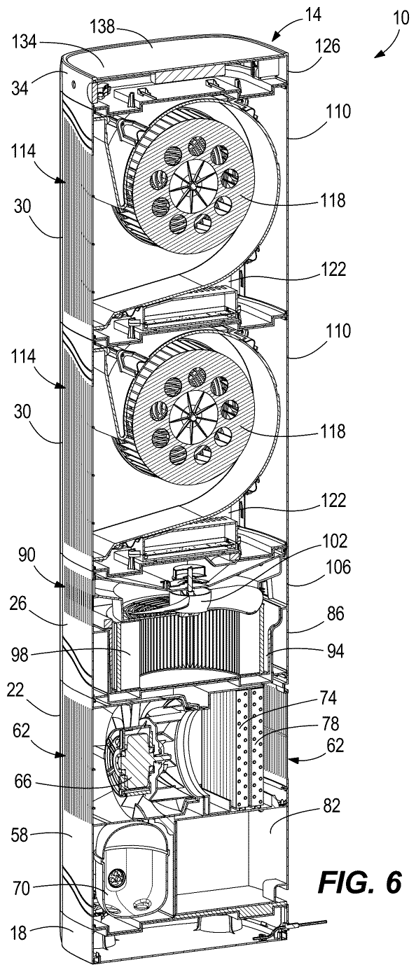

With specific reference to FIG. 6, the dehumidifier housing 58 includes a plurality of first slots 62. Air is configured to flow through the first slots 62 (e.g., through the first slots 62 in a front of the housing 58). In one example of an embodiment of the dehumidifier module 22, the dehumidifier module 22 includes a first fan 66 positioned within the dehumidifier housing 58. The first fan 66 is configured to draw air from outside of the dehumidifier module 22, through the first slots 62, and into the dehumidifier housing 58. The dehumidifier module 22 also includes a compressor 70, a condenser 74, and an evaporator 78. The compressor 70 pumps a refrigerant through the condenser 74 and the evaporator 78. The refrigerant flows through the condenser 74 to warm up the condenser 74, and the refrigerant flows through the evaporator 78 to cool down the evaporator 78. The air in the dehumidifier housing 58 flows over the cool evaporator 78. The cooled air then flows from the evaporator 78 through the condenser 74, where water vapor in the air is condensed into a liquid. The air has less humidity and is then directed out of the dehumidifier module 22 (e.g., through the first slots 62 in a rear of the housing 58).

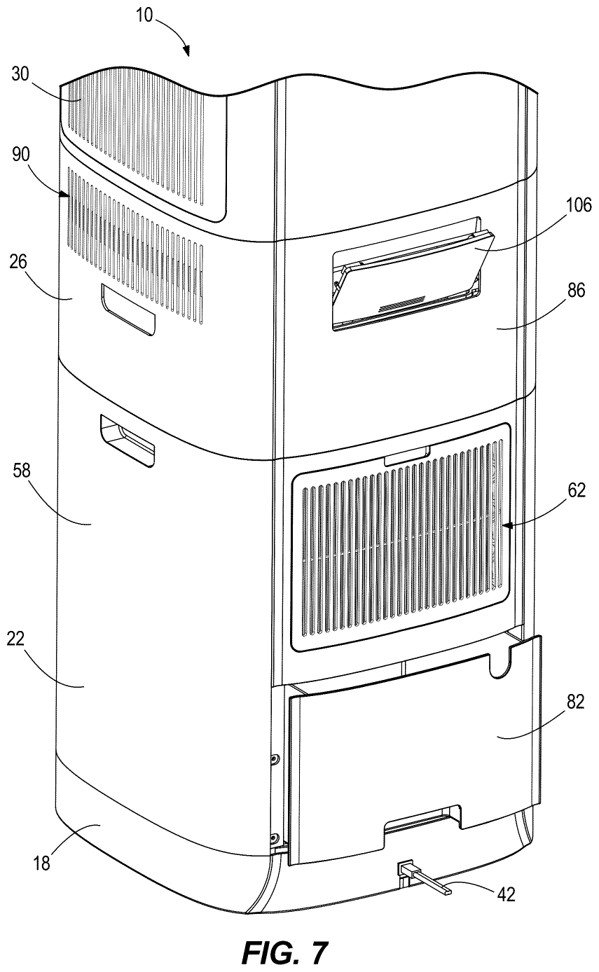

The condensed liquid flows into a drawer 82 (also referred to as a first water tank 82). The drawer 82 is positioned below the evaporator 78, such that the liquid can fall directly into the drawer 82 by gravity. The drawer 82 is slidably received by the dehumidifier housing 58 to facilitate removal to empty collected condensed liquid (shown in FIG. 7). It should be appreciated that FIG. 7 illustrates the drawer 82 as partially removed from the dehumidifier housing 58. However, it should be appreciated that the drawer 82 is configured to be fully removed or detached from the dehumidifier housing 58 to empty the liquid from the drawer 82.

Due to the weight of the compressor 70 and associated components in the dehumidifier module 22, the dehumidifier module 22 is generally heavier than the other modules 14. Accordingly, the compressor 70 is generally positioned at a bottom of the dehumidifier module 22, and the dehumidifier module 22 is positioned at a lowest position in the apparatus 10. This is to lower the center of gravity of the dehumidifier module 22 and/or the apparatus 10, and in turn, improve stability of the dehumidifier module 22 and/or the apparatus 10. In other examples of embodiments, the dehumidifier module 22 can include any different type of dehumidifier suitable to remove humidity from the air. For example, the dehumidifier module 22 can include a desiccant dehumidifier.

With reference back to FIGS. 5-7, the humidifier module 26 is shown coupled to the dehumidifier module 22. The humidifier module 26 can be mechanically and electrically coupled to the dehumidifier module 22. In addition, the humidifier module 26 can be removably coupled to the dehumidifier module 22. The dehumidifier module 22 can route power to the humidifier module 26 through electrical connections between the dehumidifier module 22 and the humidifier module 26, which is described in further detail below. In other examples of embodiments, the humidifier module 26 can be mechanically, removably, and electrically coupled to a different module 14 positioned directly below the humidifier module 26 (e.g., the base module 18). The humidifier module 26 is configured to add humidity (or water vapor) to the air. The humidifier module 26 includes a humidifier housing 86 around a periphery of the humidifier module 26. The humidifier housing 86 includes a plurality of second slots 90. Air can flow through the second slots 90. In one example of an embodiment, the humidifier module 26 is an evaporative humidifier. The humidifier module 26 includes a second water tank 94, a filter 98, and a second fan 102. The second water tank 94 is configured to hold water. The filter 98 is configured to absorb water from the second water tank 94. The second fan 102 is configured to draw air from outside of the humidifier module 26, through the second slots 90 and within the humidifier housing 86. The air is directed to flow through the moist filter 98. Humidity is added to the air, which is then directed out of the humidifier module 26 (e.g., back through the second slots 90). In other examples of embodiments, the humidifier module 26 can include any different type of humidifier suitable to add humidity to the air. For example, the humidifier module 26 can include an ultrasonic humidifier.

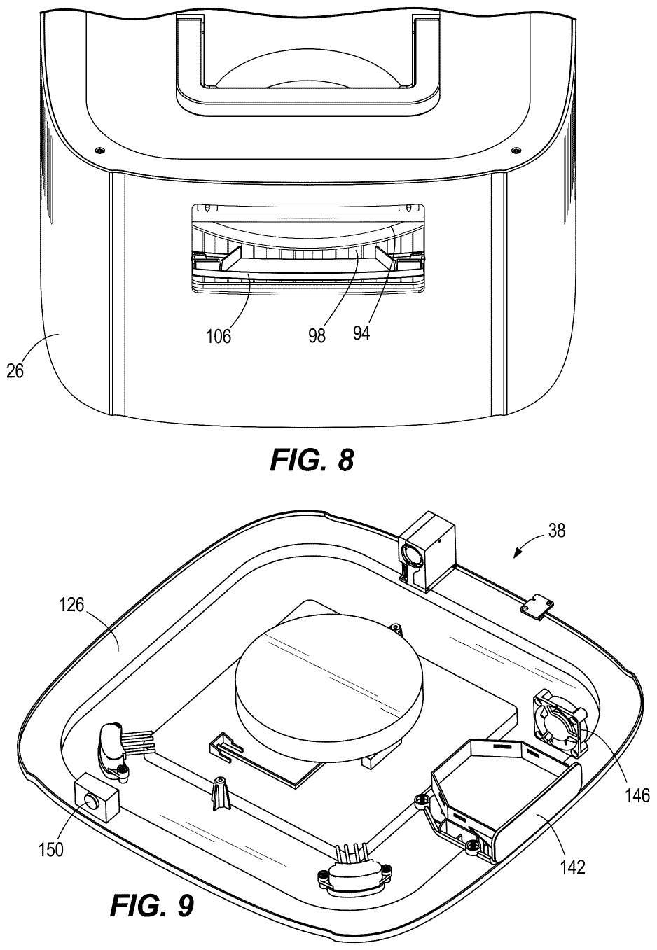

With reference to FIGS. 6-8, the humidifier module 26 includes a door 106. The door 106 is adjustable relative to the humidifier housing 86 to provide access to an interior of the humidifier housing 86. The door 106 is pivotable between a closed position (shown in FIG. 6) and an open position (shown in FIGS. 7 and 8). In the open position, liquid can be poured into the second water tank 94.

With reference to FIGS. 5 and 6, one air filter module 30 (also referred to as a first air filter module 30 or a first air purifier module 30) is coupled to the humidifier module 26, and the other air filter module 30 (also referred to as a second air filter module 30 or a second air purifier module 30) is coupled to the first air filter module 30. The first air filter module 30 can be mechanically, removably, and electrically coupled to the humidifier module 26, and the second air filter module 30 can be mechanically, removably, and electrically coupled to the first air filter module 30. The humidifier module 26 can route power to the first air filter module 30 through electrical connections between the humidifier module 26 and the first air filter module 30, which is described in further detail below. The first air filter module 30 can route power to the second air filter module 30 through electrical connections between the second air filter module 30 and the first air filter module 30, which is described in further detail below. In other examples of embodiments, each air filter module 30 can be mechanically, removably, and electrically coupled to a different module 14 positioned directly below each air filter module 30, respectively (e.g., the base module 18, the dehumidifier module 26, etc.). Each air filter module 30 is configured to purify air in a certain sized space. Larger spaces can require a plurality of air filter modules 30 to purify the air. As such, while two air filter modules 30 are shown, the apparatus 10 can include a different number of air filter modules 30 to purify the air in the space (e.g., one, three, etc.). Each air filter module 30 is configured to purify or remove contaminants and debris from the air. Each air filter module 30 includes an air filter housing 110 around a periphery of the air filter module 30. The air filter housing 110 includes a plurality of third slots 114. Air can flow through the third slots 114. In one example embodiment, each air filter module 30 includes a third fan 118 and an air filter 122. The third fan 118 is configured to draw air from outside of the air filter module 30, through the third slots 114, and within the air filter housing 110. The air flows through the air filter 122 to remove contaminants from the air. The air has less contaminants and is then directed out of the air filter module 30 (e.g., back through the third slots 114). Each illustrated air filter module 30 includes two HEPA filters positioned adjacent the third slots 114 on opposite sides of the air filter module 30 (shown in FIG. 5). In other examples of embodiments, the air filter module 30 can include different filters 122 suitable to filter contaminants from the air. In other examples of embodiments, the air filter module 30 can include a series of filters 122, such that air flows through multiple filters 122 within the air filter module 30.

With continued reference to FIGS. 5 and 6, the top module 34 is coupled to the second air filter module 30. The top module 34 can be mechanically, removably, and electrically coupled to the second air filter module 30. The second air filter module 30 can route power to the top module 34 through electrical connections between the second air filter module 30 and the top module 34, which is described in further detail below. In other examples of embodiments, the top module 34 can be mechanically, removably, and electrically coupled to a different module 14 positioned directly below the top module 34 (e.g., the dehumidifier module 22, the humidifier module 26, the first air filter module 30, etc.). The top module 34 is configured to control the operation of the air treatment apparatus 10. The top module 34 includes a top housing 126 around a periphery of the top module 34. The top housing 126 includes a plurality of apertures 130 (shown in FIG. 5). Air can flow through the apertures 130. As discussed further below, air flow through the top housing 126 can be associated with introducing scents or aromas into the surrounding environment. The top module 34 includes a user interface 134 positioned on a top side 138 of the top module 34. The user interface 134 can be used to adjust operation of each module 14, which is described in further detail below.

With reference now to FIG. 9, the top module 34 includes an aroma tray 142. The aroma tray 142 is configured to support an aroma puck (or an aroma member) (not shown) to dispense an aroma. The aroma puck can include essential oils, fragrances, or any other scent. The aroma puck can be a disposable aroma dispensing device or can be a refillable (or rechargeable) aroma dispensing device. The aroma tray 142 is configured to slide relative to the top housing 126 (shown in FIG. 5) to provide access to the tray 142. For example, the tray 142 is configured to slide away from the housing 126 to allow for insertion of the aroma puck into the tray 142 (and/or removal of the aroma puck out of the tray 142). The top module 34 includes a fourth fan 146 positioned adjacent the aroma tray 142. The fourth fan 146 is configured to blow air onto the aroma puck, such that the air picks up the aroma and then exits the top module 34. The air can enter and exit the top module 34 through the apertures 130 (shown in FIG. 5). The top module 34 can include a proximity sensor 150. The proximity sensor 150 can be used to detect movement near the air treatment apparatus 10. The proximity sensor 150 can interact with the user interface 134. In some embodiments, when the proximity sensor 150 detects movement, the user interface 134 is illuminated. The user interface 134 can then be turned off after a certain amount of time of no movement detected by the proximity sensor 150.

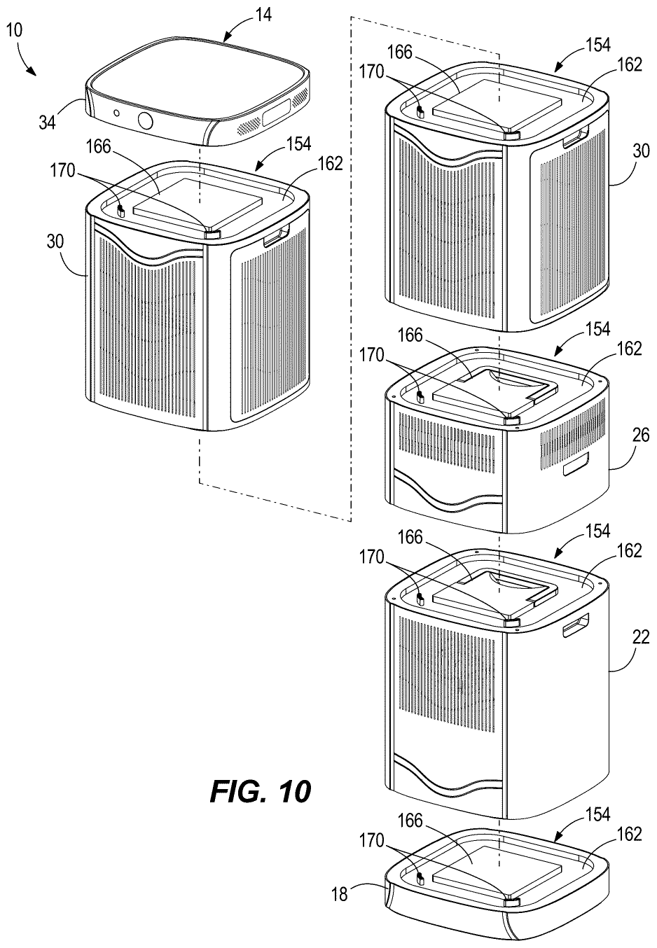

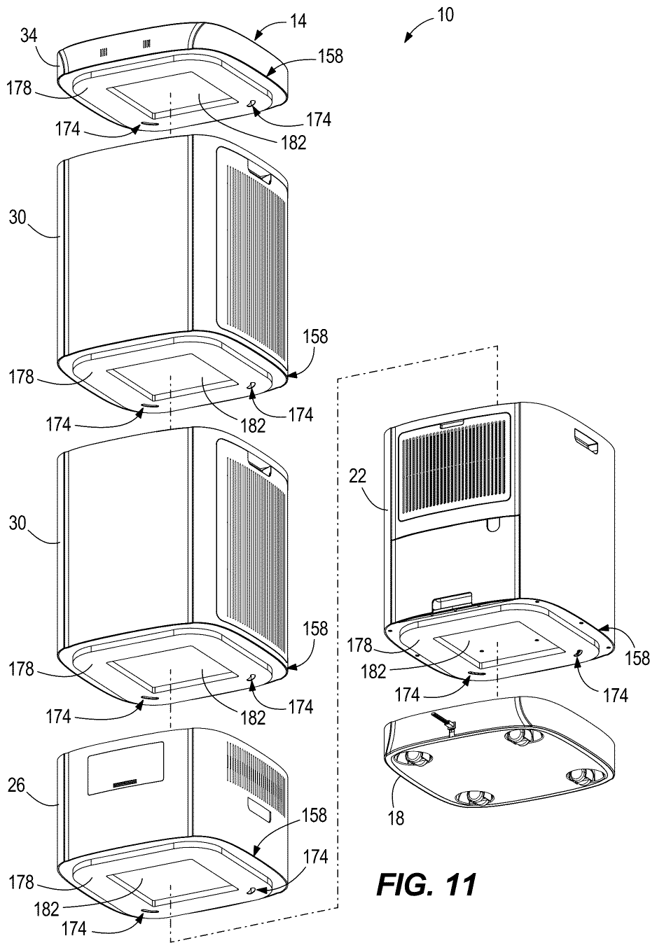

With reference to FIG. 10, each module 18, 22, 26, 30 includes a first mounting interface 154. Each first mounting interface 154 is configured to engage a corresponding second mounting interface 158 (shown in FIG. 11) on an adjacent module 22, 26, 30, 34 to couple two adjacent modules together. Each first mounting interface 154 is positioned on an upper side (or first side) of the respective module 18, 22, 26, 30. Each first mounting interface 154 includes a recessed channel 162 and a raised surface 166 at the center of the channel 162. Stated another way, the recessed channel 162 is concentric to the raised surface 166.

With reference to FIG. 11, each module 22, 26, 30, 34 includes the second mounting interface 158. Each second mounting interface 158 is positioned on a lower side (or second side) of the respective module 22, 26, 30, 34. Each second mounting interface 158 is positioned on a side of the respective module opposite the first mounting interface 154. Each second mounting interface 158 is shaped to fit with a corresponding first mounting interface 154 (shown in FIG. 10). Each second mounting interface 158 includes a projection 178 and a depressed surface 182 at the center of the projection 178. Stated another way, each projection 178 is concentric to the depressed surface 182. Each projection 178 is configured to engage (or be received by) a respective channel 162 (shown in FIG. 10), and each depressed surface 182 is configured to engage (or receive) a respective raised surface 166 (shown in FIG. 10) to couple two adjacent modules 14 together.

With reference back to FIG. 10, each module 18, 22, 26, 30 includes a plug 170. The plug 170 is configured to be received in a corresponding socket 174 (shown in FIG. 11) on an adjacent module 14 to electrically connect two adjacent modules together. In the illustrated embodiment, each base module 18, dehumidifier module 22, humidifier module 26, and air filter module 30 includes two plugs 170. Each plug 170 is positioned in the recessed channel 162. In other examples of embodiment, each base module 18, dehumidifier module 22, humidifier module 26, and air filter module 30 can include fewer than two or three or more plugs 170 positioned in any suitable location to electrically connect to a corresponding socket 174 (shown in FIG. 11) on an adjacent module 14.

With continued reference to FIG. 11, each module 22, 26, 30, 34 includes sockets 174 that are configured to receive a respective plug 170 (shown in FIG. 10) on an adjacent module 14. In the illustrated embodiment, each dehumidifier module 22, humidifier module 26, air filter module 30, and top module 34 includes two sockets 174 extending into a respective projection 178. In other examples of embodiments, each dehumidifier module 22, humidifier module 26, air filter module 30, and top module 34 can include fewer than two or three or more sockets 174 positioned in any suitable location to electrically connect to a corresponding plug 170 (shown in FIG. 10) on an adjacent module 14.

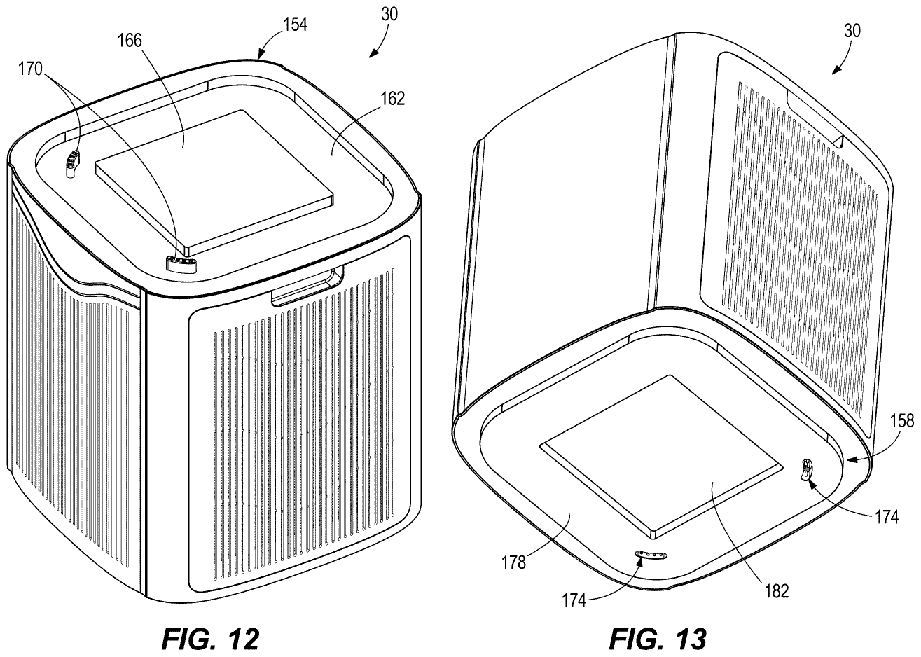

With reference now to FIG. 12, the first mounting interface 154 is illustrated in greater detail. The raised surface 166 is generally square, and the recessed channel 162 surrounds the raised surface 166. The recessed channel 162 has generally the same footprint shape as each module (shown in FIG. 3). Each plug 170 has an arcuate shape. In other examples of embodiments, each plug 170 can have a different shape (e.g., linear, triangular, etc.). FIG. 12 illustrates the first mounting interface 154 on the air filter module 30. However, it should be appreciated that the same first mounting interface 154 is integrated on the base module 18, the dehumidifier module 22, and the humidifier module 26 (shown in FIG. 10).

With reference to FIG. 13, the second mounting interface 158 is illustrated in greater detail. The depressed surface 182 is generally square, and the projection 178 surrounds the depressed surface 182. The projection 178 has generally the same footprint shape as each module (shown in FIG. 3). Each socket 174 is has an arcuate shape that corresponds with the shape of the corresponding plug 170 (shown in FIG. 10). In other examples of embodiments, each socket 174 can have a different shape (e.g., linear, triangular, etc.). FIG. 13 illustrates the second mounting interface 158 on the air filter module 30. However, it should be appreciated that the same second mounting interface 158 is integrated on the dehumidifier module 22, the humidifier module 26, and the top module 34 (shown in FIG. 11).

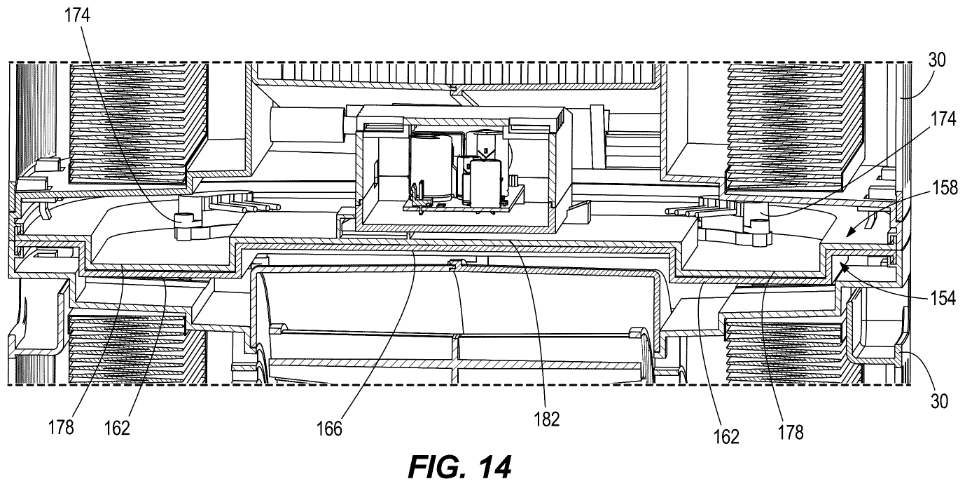

With reference to FIG. 14, engagement between the first mounting interface 154 and the second mounting interface 158 is illustrated. The projection 178 of the second mounting interface 158 is received in the channel 162 of the first mounting interface 154. The depressed surface 182 of the second mounting interface 158 abuts the raised surface 166 of the first mounting interface 154. It should be appreciated that one plug 170 (shown in FIG. 10) is received in each of the sockets 174 to electrically connect the two modules together.

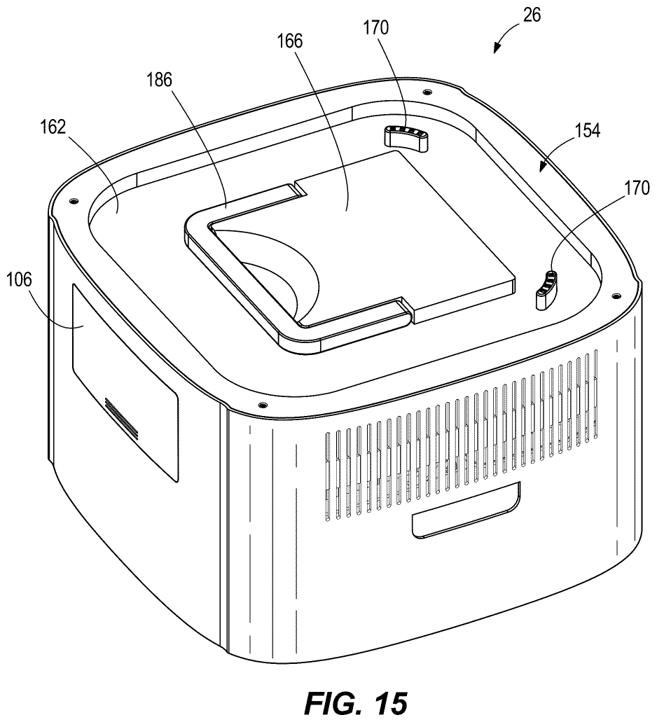

With reference now to FIG. 15, the first mounting interface 154 can include a handle 186. The handle 186 defines a portion of the raised surface 166. The handle 186 is pivotable relative to the rest of the raised surface 166 to allow a user to grip the handle 186 and carry the module 14. The handle 186 is illustrated as on the humidifier module 26. It should be appreciated that any first mounting interface 154 can include a handle 186. For example, the base module 18, the dehumidifier module 22, and/or the air filter module 30 can include a handle 186.

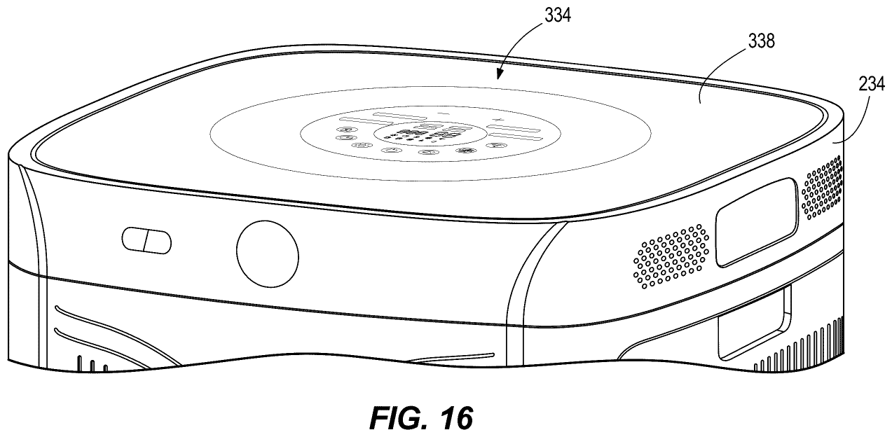

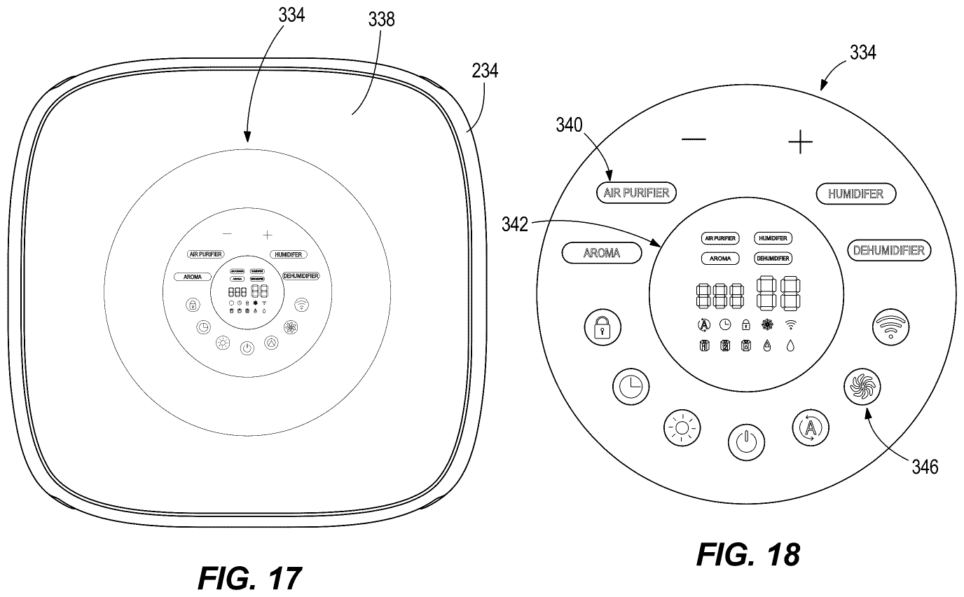

FIGS. 16 and 17 illustrate another embodiment of a top module 234 for use in the air treatment apparatus 10. The top module 234 is similar to the top module 34. Components of the top module 234 are labeled similar to like components of the top module 34 plus a value of two hundred. For brevity, only differences between the top module 234 and the top module 34 are described herein. It should be appreciated that the top module 234 can include any features as described herein with reference to the top module 34. Similarly, the top module 34 can include any features as described herein with reference to the top module 234.

The top module 234 is configured to control the operation of the air treatment apparatus 10. The top module 234 includes a user interface 334 positioned on a top side 338 of the top module 234. The user interface 334 can be used to adjust operation of each module 14.

With reference now to FIG. 18, the user interface 334 includes a plurality of buttons 340 (also referred to as controls 340). Each button 340 can serve a different function or purpose. The plurality of buttons 340 can include one button 340 to selectively activate each module 14. For example, the user interface 334 can include buttons 340 to power on and off each module 14. The plurality of buttons 340 can include buttons 340 to adjust operation of each module 14. For example, the buttons 340 can increase or decrease the speed of one of the fans in the apparatus 10, adjust a humidity percentage of the humidifier module 26 and/or the dehumidifier module 22, or adjust any other setting of one of the modules 14. The user interface 334 can also include a display 342 to indicate system data. The system data can include current settings of the apparatus 10. For example, the display 342 can provide the current humidity percentage, the ON/OFF status of each module 14, a list of the modules 14 in the apparatus 10, the amount of liquid in the drawer 82 and/or second water tank 94, the status of each air filter 122, or any other suitable setting of the apparatus 10. The user interface 334 can include indicia 346 to identify each button 340 and/or the respective settings on the display 342. The illustrated user interface 334 is circular and positioned at a center portion of the top side 338 of the top module 234 (FIG. 17). In other examples of embodiments, the user interface 334 can include any shape and can be positioned anywhere on the top module 234 to facilitate control of the apparatus 10.

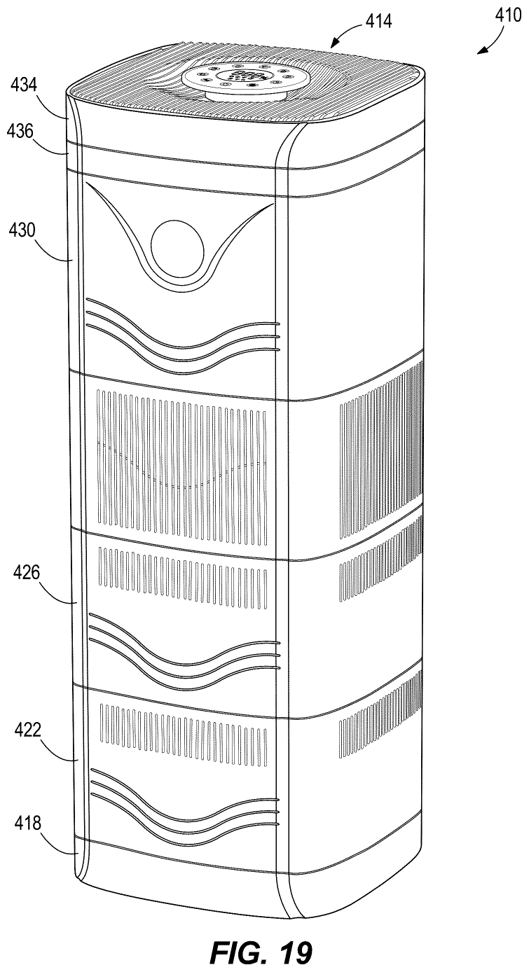

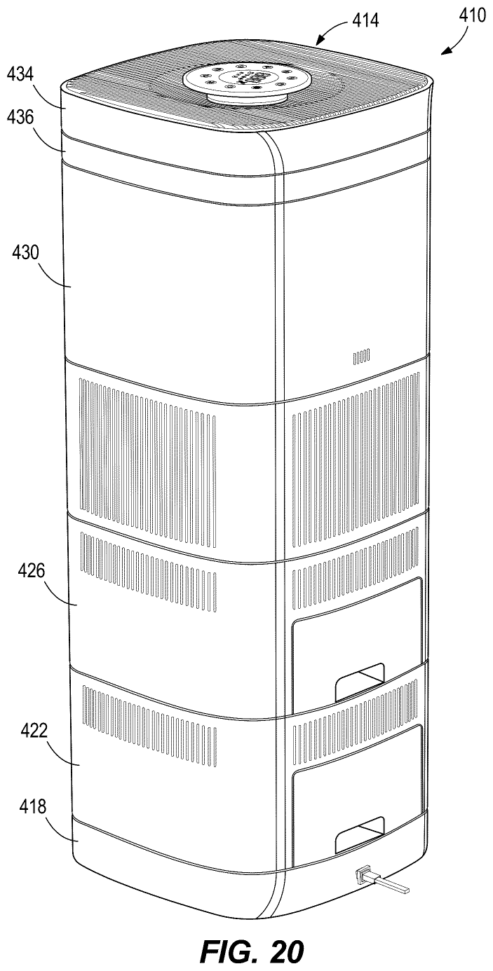

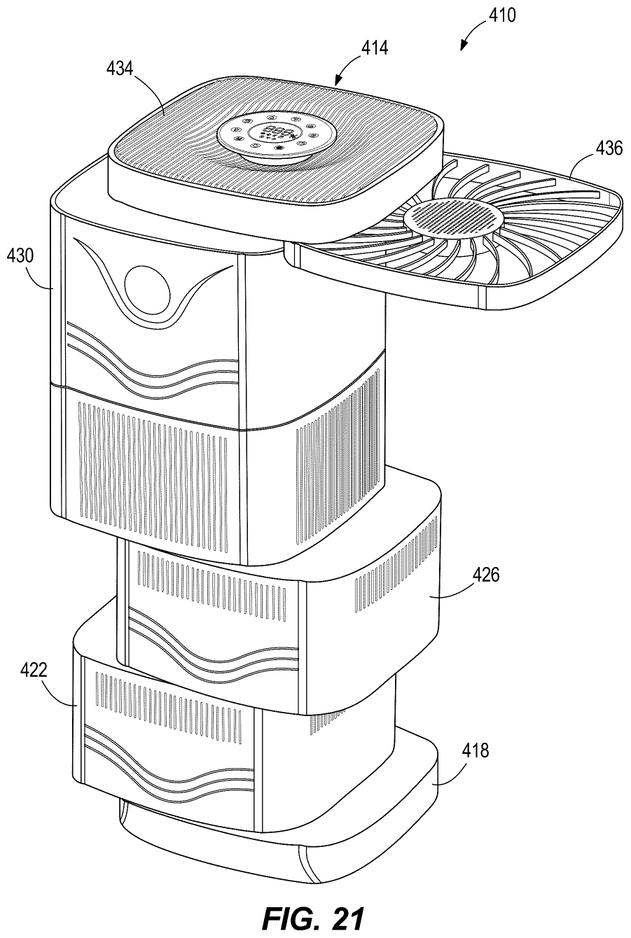

With reference to FIGS. 19-21, another embodiment of an air treatment apparatus 410 is illustrated. The air treatment apparatus 410 is similar to the air treatment apparatus 10. Components of the air treatment apparatus 410 are labeled similar to like components of the air treatment apparatus 10 plus a value of four hundred. For brevity, only differences between the air treatment apparatus 410 and the air treatment apparatus 10 are described herein. It should be appreciated that the air treatment apparatus 410 can include any features as described herein with reference to the air treatment apparatus 10. Similarly, the air treatment apparatus 10 can include any features as described herein with reference to the air treatment apparatus 410.

The air treatment apparatus 410 includes a plurality of modules 414. The plurality of modules 414 includes a base module 418 (also referred to as a first module 418), a dehumidifier module 422 (also referred to as a second module 422), a humidifier module 426 (also referred to as a third module 426), an air filter module 430 (also referred to as a fourth module 430), and a top module 434 (also referred to as a fifth module 434 or a control module 434). The plurality of modules 414 further includes an aroma module 436 (also referred to as a sixth module 436). The aroma module 436 is positioned between the air filter module 430 and the top module 434. The aroma module 436 can function similar to the aroma tray 142. As such, the aroma module 436 is configured to support an aroma puck (not shown) or another aroma containing medium (e.g., a liquid) to dispense an aromatic scent.

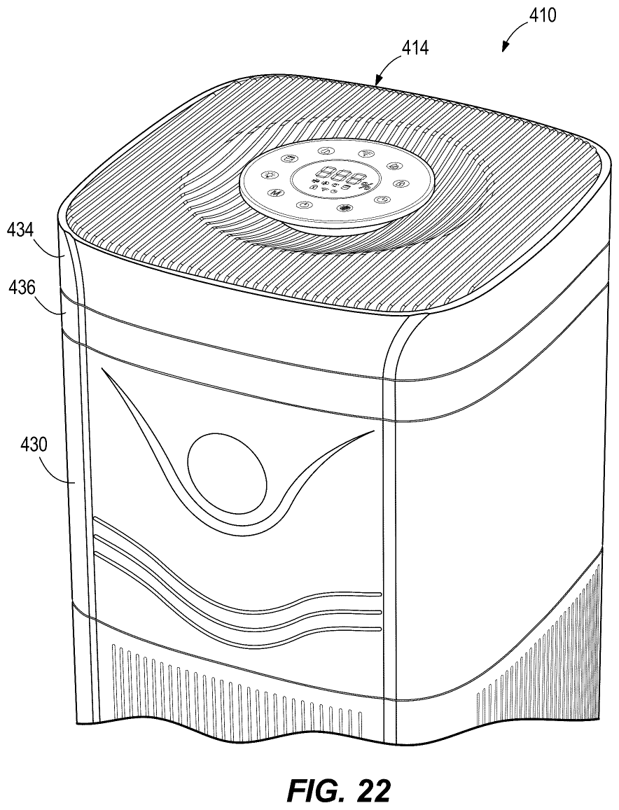

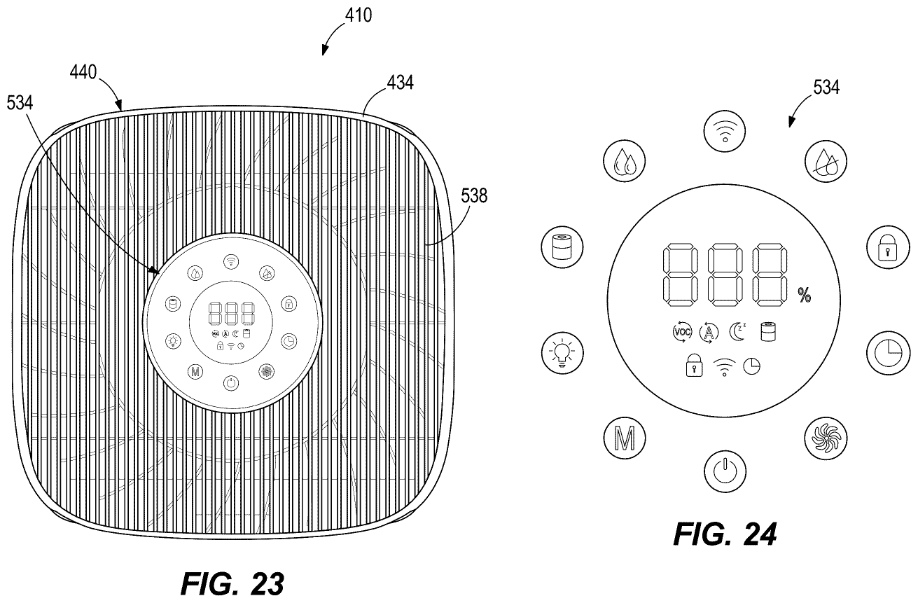

With reference now to FIGS. 22 and 23, the top module 434 includes a user interface 534 positioned on a top side 538 of the top module 434. The user interface 534 can be used to adjust operation of each module 414 in the apparatus 410. The top module 434 includes a plurality of fourth slots 440 extending along the top side 538. Air can flow through the fourth slots 440.

With reference now to FIG. 24, the user interface 534 can include any features or function as described herein with reference to the user interfaces 134, 334.

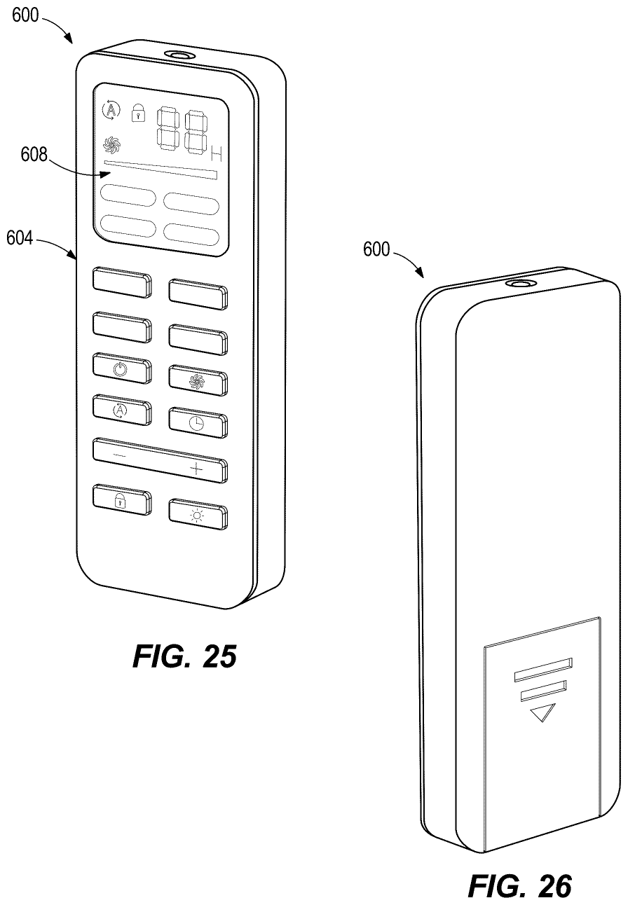

With reference now to FIGS. 25 and 26, a remote 600 (also referred to as a controller 600) can control operation of the apparatus 10, 410. The remote 600 can wirelessly communicate with the apparatus 10, 410 to adjust operation of each module 14, 414 in the apparatus 10, 410. The remote 600 can function similar to the user interface 134, 334, 534, but provide the control wirelessly. The remote 600 can transmit signals to a receiver (not shown) in the top module 34, 234, 434. The remote 600 can be battery powered.

With specific reference to FIG. 25, the remote 600 can include a plurality of buttons 604 and a display 608. The buttons 604 can be selectively actuated to transmit signals to the apparatus 10, 410. The buttons 604 can function similar to the buttons 340. The display 608 can indicate system data. The display 608 can function similar to the display 342.

Each apparatus 10, 410 is adjustable between a plurality of arrangement configurations. Each configuration includes a different arrangement of modules 14, 414. In one example of an embodiment, the apparatus 10 can be adjusted between eleven different configurations.

In a first configuration, the apparatus 10 includes one base module 18, one air filter module 30 coupled to base module 18, and one top module 34 coupled to the air filter module 30. In this configuration, the apparatus 10 does not include any humidifier modules 26 or dehumidifier modules 22.

In a second configuration, the apparatus 10 includes one base module 18, one dehumidifier module 22 coupled to the base module 18, and one top module 34 coupled to the dehumidifier module 22. In this configuration, the apparatus 10 does not include any humidifier modules 26 or air filter modules 30.

In a third configuration, the apparatus 10 includes one base module 18, one humidifier module 26 coupled to the base module 18, and one top module 34 coupled to the humidifier module 26. In this configuration, the apparatus 10 does not include any dehumidifier modules 22 or air filter modules 30.

In a fourth configuration, the apparatus 10 includes one base module 18, a first air filter module 30 coupled to the base module 18, a second air filter module 30 coupled to the first air filter module 30, and one top module 34 coupled to the second air filter module 30. In this configuration, the apparatus 10 does not include any dehumidifier modules 22 or humidifier modules 26.

In a fifth configuration, the apparatus 10 includes one base module 18, one dehumidifier module 22 coupled to the base module 18, one air filter module 30 coupled to the dehumidifier module 22, and one top module 34 coupled to the air filter module 30. In this configuration, the apparatus 10 does not include any humidifier modules 26.

In a sixth configuration, the apparatus 10 includes one base module 18, one humidifier module 26 coupled to the base module 18, one air filter module 30 coupled to the humidifier module 26, and one top module 34 coupled to the air filter module 30. In this configuration, the apparatus 10 does not include any dehumidifier modules 22.

In a seventh configuration, the apparatus 10 includes one base module 18, one dehumidifier module 22 coupled to the base module 18, one humidifier module 26 coupled to the dehumidifier module 22, and one top module 34 coupled to the humidifier module 26. In this configuration, the apparatus 10 does not include any air filter modules 30.

In an eighth configuration, the apparatus 10 includes one base module 18, a dehumidifier module 22 coupled to the base module 18, a first air filter module 30 coupled to the dehumidifier module 22, a second air filter module 30 coupled to the first air filter module 30, and one top module 34 coupled to the second air filter module 30. In this configuration, the apparatus 10 does not include any humidifier modules 26.

In a ninth configuration, the apparatus 10 includes one base module 18, a humidifier module 26 coupled to the base module 18, a first air filter module 30 coupled to the humidifier module 26, a second air filter module 30 coupled to the first air filter module 30, and one top module 34 coupled to the second air filter module 30. In this configuration, the apparatus 10 does not include any dehumidifier modules 22.

In a tenth configuration, the apparatus 10 includes one base module 18, one dehumidifier module 22 coupled to the base module 18, one humidifier module 26 coupled to the dehumidifier module 22, one air filter module 30 coupled to the humidifier module 26, and one top module 34 coupled to the air filter module 30. In this configuration, the apparatus 10 includes one of each module 14.

In an eleventh configuration, the apparatus 10 includes one base module 18, one dehumidifier module 22 coupled to the base module 18, one humidifier module 26 coupled to the dehumidifier module 22, a first air filter module 30 coupled to the humidifier module 26, a second air filter module 30 coupled to the first air filter module 30, and one top module 34 coupled to the second air filter module 30. In this configuration, the apparatus 10 includes two air filter modules 30 and one of each other module 14.

In each configuration, the apparatus 10 includes the base module 18 and the top module 34. The base module 18 receives power through the power cord 42 and power is routed to the other modules 14 by the respective plugs 170 and sockets 174. In each configuration with the dehumidifier module 22, the dehumidifier module 22 is coupled to the base module 18. The dehumidifier module 22 is configured to be heavier than the other modules 14. As such, the stability of the apparatus 10 is improved with the dehumidifier module 22 at the bottom of the apparatus 10. In each configuration with the dehumidifier module 22 and the humidifier module 26, the humidifier module 26 is coupled to the dehumidifier module 22. In each configuration with the humidifier module 26 and without the dehumidifier module 22, the humidifier module 26 is coupled to the base module 18.

It should be appreciated that the apparatus 10 can have fewer or more configurations than eleven. It should also be appreciated that the apparatus 410 can include the same configurations as described herein with reference to the apparatus 10. Further, the apparatus 410 can include different combinations due to the aroma module 436.

Although the invention has been described in detail with reference to certain preferred embodiments, variations and modifications exist within the scope and spirit of one or more independent aspects of the invention as described. Various features and advantages of the invention are set forth in the following claims.

1. A modular air treatment assembly comprising:
a base module;
at least one intermediate module stacked on the base module, the at least one intermediate module removably connected to the base module; and
a top module stacked on the at least one intermediate module, the at least one top module removably connected to the intermediate module,
wherein electrical power provided to the base module is communicated to the at least one intermediate module and the top module.

2. The modular air treatment assembly of claim 1, wherein the base module includes an illumination source.

3. The modular air treatment assembly of claim 2, wherein the illumination source is positioned around a periphery of a bottom side of the base module.

4. The modular air treatment assembly of claim 1, wherein the at least one intermediate module includes a dehumidifier module.

5. The modular air treatment assembly of claim 4, wherein the dehumidifier module includes a water tank configured to receive water condensed from intake air drawn from outside the dehumidifier module.

6. The modular air treatment assembly of claim 5, wherein the water tank is a drawer that partially defines an external housing of the dehumidifier module.

7. The modular air treatment assembly of claim 6, wherein the drawer is configured to be detached from the dehumidifier module.

8. The modular air treatment assembly of claim 1, wherein the at least one intermediate module includes a humidifier module.

9. The modular air treatment assembly of claim 8, wherein the humidifier module includes a door that partially defines an external housing of the humidifier module.

10. The modular air treatment assembly of claim 9, wherein the door is configured to pivot between a closed position and an open position, wherein in response to the door being in the open position, a second tank is configured to receive a humidification liquid through the door.

11. The modular air treatment assembly of claim 4, wherein the at least one intermediate module includes a humidifier module.

12. The modular air treatment assembly of claim 11, wherein the humidifier module is stacked on the base module, the humidifier module is removably connected to the base module, and the dehumidifier module is stacked on the humidifier module, the dehumidifier module is removably connected to the humidifier module.

13. The modular air treatment assembly of claim 11, wherein the dehumidifier module is stacked on the base module, the dehumidifier module is removably connected to the base module, and the humidifier module is stacked on the dehumidifier module, the humidifier module is removably connected to the dehumidifier module.

14. The modular air treatment assembly of claim 1, wherein the at least one intermediate module includes an air filter module including a first fan and an air filter.

15. The modular air treatment assembly of claim 14, wherein the air filter includes a HEPA filter.

16. The modular air treatment assembly of claim 1, wherein the at least one intermediate module includes a humidifier module, a dehumidifier module, or at least one air filter module.

17. The modular air treatment assembly of claim 16, wherein each intermediate module includes a first mounting interface positioned on a first side of the module, and a second mounting interface positioned on a second side of the module, each first mounting interface is configured to engage the second mounting interface of an adjacent intermediate module.

18. The modular air treatment assembly of claim 17, wherein each first mounting interface includes a recessed channel positioned concentric to a central projection, and each second mounting interface includes a raised projection positioned concentric to a central recess, wherein the recessed channel of the first mounting interface is configured to receive the raised projection of the second mounting interface of an adjacent intermediate module, and the central projection of the first mounting interface is configured to be received by the central recess of the second mounting interface of the adjacent intermediate module.

19. The modular air treatment assembly of claim 18, wherein the first mounting interface includes at least one electrical plug and the second mounting interface includes at least one electrical socket, wherein the at least one electrical plug of the first mounting interface is configured to be received by the at least one electrical socket of the second mounting interface of the adjacent intermediate module to electrically connect adjacent intermediate modules.

20. The modular air treatment assembly of claim 1, wherein the top module includes a fan in fluid communication with a removable tray, the removable tray is configured to receive an aroma dispensing device, and the fan is configured to generate air flow directed towards the aroma dispensing device.
